(19) United States
(12) Patent Application Publication
(10) Pub. No.: US 2005/0015607 A1
(43) Pub. Date: Jan. 20, 2005

(54) Copy-protected optical information carrier and methods for its manufacture and operation

(76) Inventor: Tom Ellingsen, Rena (NO)

Correspondence Address: BURNS DOANE SWECKER & MATHIS L L P, POST OFFICE BOX 1404, ALEXANDRIA, VA, 22313-1404, US

(21) Appl. No.: 10/498,090

(22) PCT Filed: Dec. 19, 2001
(86) PCT No.: PCT/IB01/02578

(51) Int. Cl. H04L 9/32

(52) U.S. Cl. 713/193

(57) ABSTRACT

Use of an optical information carrier such as a CD-ROM (1) is limited to reading and storing if its content in a single computer device by detachment of a security member (9) bonded to a part (8) of the information or data carrying structures storing control data needed for enabling the computer device to complete reading and storing of the information on the disk. By entry into the computer device of a unique secret identification code carried by the security member (9) the computer device is enabled to resume and complete the reading and storing operations, whereas subsequent attempts of reading and storing of the information with a different computer deceive will fail due to the unavailability of the control data modified by detachment of the security member (9).

The present invention relates to protection of optical information carriers, in particular CD- and CD-ROM-disks against unauthorized copying of the information content stored in the information or data structures of such an information carrier with the aim of limiting lawful use of said information to a single reproduction device such as a computer device, in particular a personal computer.

### BACKGROUND ART

Optical information carriers in the form of CD- or CD-ROM disks have become a very popular and widely used storage medium for various types of information including music, computer software products, computer games etc.

In regular and lawful trade the information content on a CD-ROM disk is intended for use by a single user only, but misappropriation of the information content by unauthorized copying has become a major problem both at a smaller scale in the form of non-profit private use and at larger scale in the form of actual piracy traffic for commercial purposes.

Irrespective of the nature of the copying traffic, copying and piracy problems have resulted in huge economic losses for the music and computer software industry.

In order to combat piracy software producers have developed and implemented a number of different approaches including encryption of information, special data formatting, complex installation procedures and use of passwords to mention just a few. Thus, a customary approach to protection has been to incorporate a computer readable identification code onto the information carrier and supply the same code in accessible form to the purchaser in the course of a regular and lawful sales transaction, whereby a computer loaded with the information carrier thus protected will only be enabled to read the stored information content after entry of the identification code by user operation. Evidently, the protection offered by this concept is unsatisfactory in the sense that repeated use of the identification code supplied as part of the sales transaction by the purchasing user as well as other users related to him cannot be prevented.

Moreover, various relatively simple programmes enabling direct copying of, the content of a CD-ROM disk, even if protected by an identification code, can be downloaded from the Internet. Copying software of this type simply localizes the code stored on the DC-ROM and generates the control data needed to enable the computer for reading the full information content thereon.

Another problem involved in the use of prior art anti-piracy approaches has been a wide-spread resistance of end users to these schemes due to restrictions or limitations imposed on otherwise acceptable use of the information carrier, such limitations typically including an inability to “test before buying”, restrictions on the generation of legitimate back-up copies and the failure of password protection once the password or identification code has been divulged or discovered. The failure of copy protection concepts to gain end user acceptance has been seen as such a serious problem that industry and commerce have in many cases abandoned protection efforts and chosen to rely on customer integrity to abide by copyright laws.

In an attempt to provide a solution to these problems a copy protection method has been disclosed in International Patent Application WO 98/41979, which is generally based on a purposeful modification of the accessibility of encoded information on an optical storage medium. Among various suggested implementations of this concept one embodiment is directed to modification of the optical storage medium by provision of a device, which purposefully damages the optical medium, when the information content thereon is initially accessed, whereby upon subsequent attempts of information accessing the previous access can be detected by purposeful generation of detection errors. The device used for damaging the optical storage medium may be in the form of a ribcord attached to the storage medium, which in the course of an initial use must be manually, detached by the user to implement the intentional damage to the information carrier for preventing future illegal copying.

However, since in this solution manual detachment of the damaging device can only be effected after completion of initial reading of the full information content, this method does not provide any improved or satisfactory protection by leaving the option of non-detachment of the ribcord and, thereby, unrestricted use of the storage medium on a different computer by the same or a different user.

### SUMMARY OF THE INVENTION

On the background outlined above, it is the object of the present invention to provide a relatively simple, uncomplicated and inexpensive solution to the protection of optical information carriers of the kind set forth against illegitimate copying, by which the shortcomings and drawbacks of prior art solutions are avoided or at least significantly reduced and legitimate use of the information carrier is restricted to a single use by a single user on a single computer, while still allowing generation of a back-up copy, but preventing subsequent misappropriation.

In a first aspect of the invention, an optical information carrier is provided, which comprises a circular disk-shaped substrate member of a relatively rigid transparent material and an information carrying layer applied to one surface of the substrate member and providing on the side thereof facing the substrate member a reflective surface and a plurality of information or data carrying structures, information stored in said structures being readable by an optical reading system of a computer device for inputting and storing utility information to said computer device, said information including in addition to said utility information control data required for the inputting and storing operations of the computer device, said control data being confined to a subset of said information or data carrying structures with a predetermined position in said layer.

To accomplish the object as stated above such an information carrier is characterized, according to the invention, in that a detachable security member is bonded to a part of the information carrying layer including a part of said subset of the information or data carrying structures by a bond causing modification of the reflective surface and/or the control data stored in said part of the subset to remove readability of said control data by detachment of the security member, said security member carrying a unique secret identification code, which is made accessible to a user only by said detachment, said control data including information causing the computer device to invite a user to enter said identification code and to disrupt inputting of said utility information to the computer until entry of the security code has been completed.

In use of this information carrier the user will initially load the carrier, such as a CD-ROM disk into the optical reading system such as the CD-ROM drive of his computer, which then starts reading of the control data. Upon detection of the identification code embedded in the control information and data associated therewith the computer will disrupt the reading process and display a message to the user inviting him to remove the information carrier from the optical reading system to detach to security member and access the identification code for inputting it into the computer, e.g. via the keyboard, to enable the computer to resume and complete reading of the full information content of the information carrier including the utility information forming part thereof, such as a software application or a computer game.

By the detachment of the security member the readability of the control data original stored in the information and data carrying structures will be removed and subsequent attempts to use the information carrier with a different computer will be unsuccessful, since control data needed to enable such a computer to conduct the reading process will no longer be available or readable.

In a simple preferred embodiment the security member may comprise a label-like member adhesively bonded to the information or data carrying layer, e.g. by forming part of the protective layer which conventionally covers the side of the information or data carrying layer facing away from the transparent substrate member.

The information code, which upon purchase of the information carrier must be hidden to the user, is provided e.g. in the form of a printed sequence of alpha-numeric characters on the side of the security label bonded to the information carrying layer and behind the part of this layer removed together with the security member.

To access the identification code the adhesive bond between the label-like member and said part of the information carrying layer may preferably be adapted to allow separation of the detached part of the information carrying layer and label-like member itself, which carries the identification code, e.g. by peeling-off, to disclose the identification code. Alternatively a scraping technique as known in the art could be used for this purpose.

According to a second aspect of the invention, a method of manufacturing an optical information carrier is provided, comprising the steps of
providing a circular disk-shaped substrate member of a relatively rigid transparent material,
applying an information carrying layer to one surface of the substrate member, said layer providing on the side thereof facing the substrate member a reflective surface and a plurality of information or data carrying structures,
storing information in said structures, which is readable by an optical reading system of a computer device for inputting and storing utility information to said computer device, said information including in addition to said utility information control data required for the inputting and storing operation of the computer device, said control data being confined to a subset of said information and data carrying structures with a predetermined position in said layer.

According to the invention this method is characterized by the additional steps of
providing a security member carrying a unique secret identification code
bonding said security member to a part of said information and data carrying layer containing a part of said subset by a bond causing modification of said reflective layer and/or the control data stored in said part of the subset to remove readability of said control data by detachment of the security member, and
structuring said control information to include information causing the computer device to invite a user to enter said identification code and to disrupt inputting of said useful information to the computer until entry of the security code has been completed.

By a preferred implementation of this method the information included in the control information by the structuring step may comprise a time delay after display of the invitation to the user, within which detachment of the security member from the information carrier and divulgation and entry of the identification code must be completed. By such a time delay, which could e.g. 30 to 60 seconds, the protection against illegitimate use of the information carrier on a different computer device will be further improved.

Further, according a third aspect the invention also relates to a use of an optical information carrier as defined, comprising the steps of
entering the optical information carrier into an optical reading system of a computer device,
controlling the computer device by the control data contained in said subset of thee information and data structures on the optical information carrier to request entry of said unique secret identification code,
removing the optical information carrier from said optical reading system,
detaching said security member from the optical information carrier, and
accessing said unique identification code carried by the security member and entering said code into said computer device to enable said computer device for inputting and storing of said utility information.

By a preferred implementation of this operation method the controlling step may comprise control of the computer device to request said removing, detaching, accessing and entering steps to be completed within a specified time delay after said request and to disable the computer from further operation with respect to the information carrier after lapse of such a time delay.

### BRIEF DESCRIPTION OF THE DRAWINGS

In the following the invention will be further explained with reference to the accompanying drawings, on which

FIG. 1 is a front view of an optical information carrier in the form of a CD-ROM disk embodying the invention,

FIG. 2 is an enlarged sectional view of a part of the information carrier in FIG. 1 along the lines II-II,

FIG. 3 is an enlarged section of the part of FIG. 2, respectively, within the frame designated III,

FIGS. 4 and 5 are enlarged sectional and plan views, respectively, of a security member detached from the information carrier shown in FIGS. 1 to 3, and

FIG. 6 is a flow diagram illustrating the use of a copy-protected information carrier according to the invention.

### DETAILED DESCRIPTION

In the illustrated embodiment the optical information carrier according to the invention is a circular relatively thin CD-ROM disk 1 having a center hole 2 for engagement with the rotary drive mechanism of the CD-ROM drive of a computer device such as a personal computer

As known in the art the CD-ROM disk is typically composed of a circular plate-shaped substrate member 3 of a transparent, relatively rigid plastic material such as polycarbonate serving as the supporting basis structure of the disk.

On one side of the substrate member 3 a relatively thin information carrying layer 4 is applied to the substrate member. The information carrying layer 4 is a reflective metallic layer in which a plurality of information and data carrying structures in the form of so-called lands and pits 5 and 6 are formed along a single spiral track extending from the circumference of the disk 1 towards the center hole 2. As known in the art the mutual separation of neighbouring windings in the spiral track providing the information and data carrying structures may be down to approximately 0.6 μm to provide the well-known large storage capability of the CD-ROM disk.

The information and data carrying layer 4, the thickness of which may be about 1 μm may be bonded to the substrate member 3 by a conventional stamping process, by which the pits 6 are pressed into the transparent material of the substrate member 3. Conventionally the level difference of the lands and pits 5 and 6 forming the information and data carrying structures amounts to a quarter wavelength of the interrogating laser beam used for the reading operation as explained below.

During the reading operation the disk 1 is caused by the CD-ROM drive of a personal computer into rotational motion with constant linear velocity, while reading is performed by means of an interrogating beam of laser light focussed at the level of the lands 5 of the information and data carrying structure during radial propagation of the laser light source from the circumference towards the center of the disk 1. Thus, the angular rate of rotation of the disk 1 is increased as the interrogating laser beam travels from the circumference towards the center of the disk 1 to accomplish a constant linear speed of detection. The light pulses returned by the reflective layer 4 in response to the impinging interrogation beam are converted into digital data, in which binary digits “1” and “0” may correspond e.g. to light reflected from the lands 5 and the pits 6, respectively.

On the side facing away from the substrate member 3 the information and data carrying layer is typically covered by a protective coating 7, which on the external side facing away from the substrate member 3 may be provided with text information to identify and explain the content of the CD-ROM disc such as a computer software application or a computer game.

The information stored in the information and data carrying structures of the layer 4 includes, in addition to utility information relating to the substance of the software application or computer game contained on the disk 1, also control data, which is required by the computer device for enabling appropriate conduct of the reading operation and inputting and storing of the digital information generated by conversion of the light or optical information obtained by the reading operation. Thus, during the reading operation the control data must initially be accessed and entered into the computer before meaningful reading and storage of the utility information can be conducted.

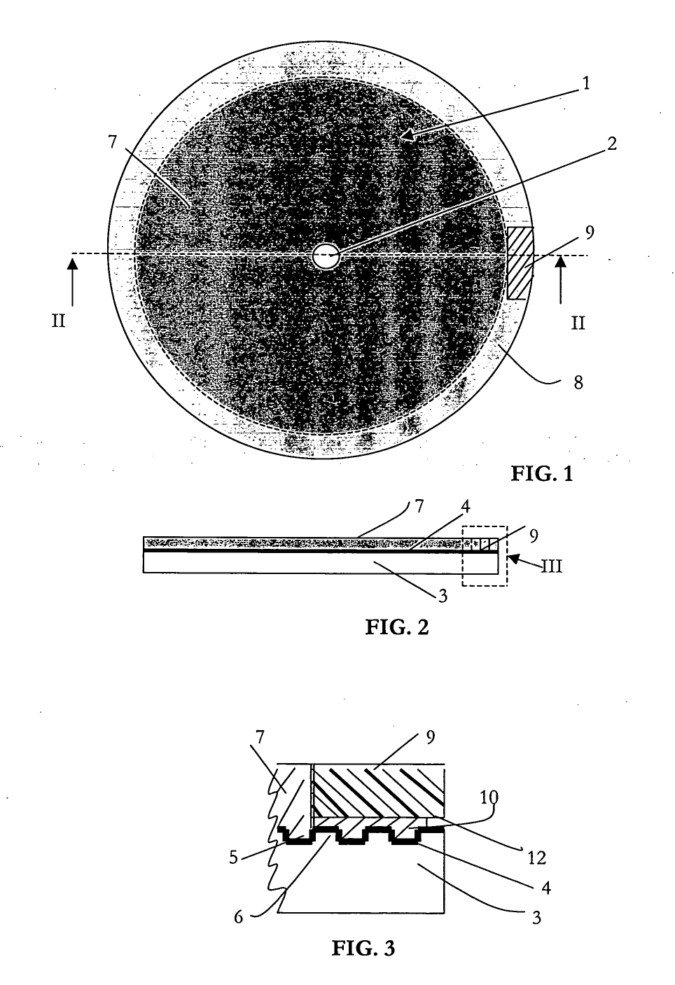

Conventionally, the control data are confined to a subset of the information and data carrying structures in the layer 4 with a predetermined and defined geographical location on the disk 1. Most commonly the control data will as shown schematically in FIG. 1 be confined to a relatively narrow edge region 8 extending just inside the circumference of the disk 1 and having a width of e.g. 6 mm out of the total disk diameter of about 120 mm. The control data may, however be localized in any predetermined geographical position on the disk, e.g. in the innermost part of the information carrying layer around the center hole 2.

In accordance with the present invention, the CD-ROM disk 1 is provided with a detachable security member generally designated by 9 carrying a unique secret identification code, which can be accessed by the user only by detachment of the security member 8 from the CD-ROM disk 1 and must be entered by the user into the computer, before reading of the utility information stored in the CD-ROM disk can be completed. At the same time detachment of the security member 8 from the CD-ROM disk will cause removal or at least destruction of the accessibility of at least part of the control data needed by a computer for successful reading of the stored information and thereby prevent subsequent use of the CD-ROM disk on a different computer.

As best shown in the enlarged view in FIG. 3 the detachable security member 9 comprises, in the illustrated embodiment a label-like member of limited size replacing a section of equal size of the protective coating 7 in the region 8 covering the subset of the information and data carrying structures of the layer, in which the control data is confined, in the illustrated case at the circumference of the disk 1.

The label-like member 9 may be bonded to the information or data carrying layer 4 by an adhesive bond, such that detachment of the label-like security member 9 will cause removal of the underlying part of the information and data carrying reflective layer 4.

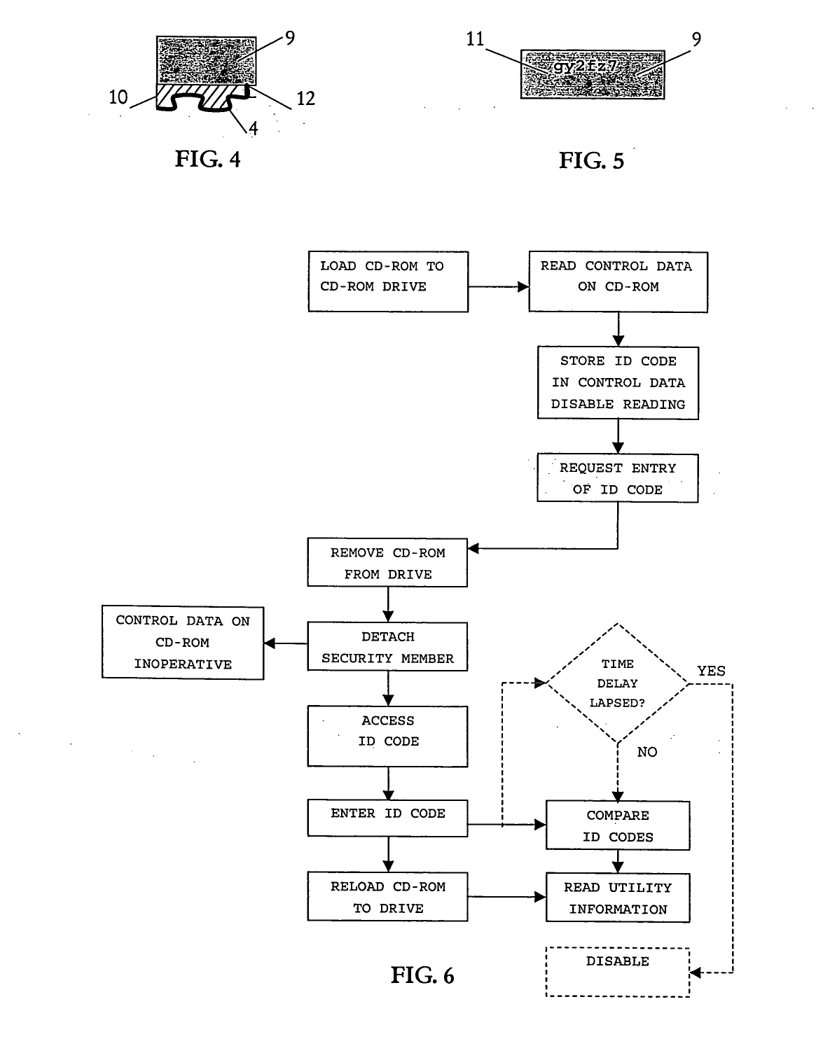

As shown in FIGS. 4 and 5 the unique secret identification code 11 may be provided on the side of the label-like security member 9 facing the reflective information and data carrying layer 4, e.g. in the form of a limited sequence of alpha-numerical characters. Thus, before detachment of the security member 9 the identification code 11 will not be visible and thereby readable to the user. After detachment of the security member 9 the identification code 11 will still be at least partly covered by the part of the reflective metallic layer 4 removed together with it. For disclosure of the identification code, the adhesive bond between the security member 9 and the reflective layer 4 may be confined to an area leaving a narrow edge region 12 of the detached security member 9 without the adhesive bond to allow removal of the reflective layer covering the identification code 11 by peeling-off. Alternatively, a scraping technique as known in the art could be employed for removal of the reflective layer covering the identification code. To facilitate its detachment the security member may be provide with a relatively small projecting gripping flap not bonded to the reflective layer 4.

As a further essential feature of the invention the control data stored in the information and data carrying structures of the disk 1 must be structured or organized to include information, which in connection with the initial reading of the control data for enabling the computer device will cause the computer device to disable the reading operation, such that the utility information is not entered into then computer device at this time but an invitation is conveyed to the user to remove the CD-ROM disk from the CD-ROM drive for detachment of the security member and accessing the identification code for entry of this code into the computer, e.g. by keyboard operation. Evidently the control data must also include the identification code itself for comparison with the code entered by the user via the keyboard. The control data may further include a time delay after display of the invitation to the user, within which the removal of the CD-ROM disk from the drive, the detachment of the security member and the divulgation and entry of the identification code must be completed, and a command to disable operation of the computer device with respect to the information carrier upon lapse of this time delay

The control data thus structured form part of the overall information and data content to be stored in the information and data carrying structures of the CD-ROM disk and are stored in the information or data carrying layer 4 during manufacture of the disk.

As illustrated in the flow diagram in FIG. 6 the sequence of operations involved in the use of an optical information carrier according to the invention will start with loading of the CD-ROM disk into the CD-ROM drive of the computer device, which will then read the control data. As a result thereof, the computer device will bar further reading of the utility information stored in the disk and invite the user to remove the CD-Rom from the drive, detach the security member for accessing the identification code and enter the identification code thus disclosed into the computer, e.g. as mentioned above within a specified time delay, after lapse of which operation of the computer device with respect to the CD-ROM disk will be disabled, if the identification code has not been entered.

In windows application this invitation will typically be given by display of the invitation in a window containing a specified field for entry of the identification code, which will be compared by the computer device with the identification code already stored as part of the control information.

Subsequently, by reloading of the CD-ROM into the drive the computer device will now complete the reading operation and store the complete utility information relating to the software application or computer game stored on the CD-ROM.

Whereas the full content of the CD-ROM will be available for future use, including generation of a back-up copy on the computer device, into which it has been entered in the first place, subsequent attempts of using the CD-ROM with a different computer device will not be possible, since the control data needed by the computer to access the utility information will have become damaged to an extent preventing the computer from reading of the stored utility information.

1. An optical information carrier comprising a circular disk-shaped substrate member of a relatively rigid transparent material and an information carrying layer applied to one surface of the substrate member and providing on the side thereof facing the substrate member a reflective surface and a plurality of information or data carrying structures, information stored in said structures being readable by an optical reading system of a computer device for inputting and storing utility information to said computer device, said information including in addition to said utility information control data required for the inputting and storing operations of the computer device, said control data being confined to a subset of said information or data carrying structures with a predetermined position in said layer, wherein the improvement comprises a detachable security member is bonded to a part of the information carrying layer including a part of said subset of the information or data carrying structures by a bond causing modification of the reflective surface and/or the control data stored in said part of the subset to remove readability of said control data by detachment of the security member, said security member carrying a unique secret identification code, which is made accessible to a user only by said detachment, said control data including information causing the computer device to invite a user to enter said identification code and to disrupt inputting of said utility information to the computer until entry of the security code has been completed.

2. An information carrier as claimed in claim 1, wherein said security member comprises a label-like member adhesively bonded to said part of the information carrying layer.

3. An information carrier as claimed in claim 1, wherein the adhesive bond between the label-like member and said part of the information carrying layer allows separation of said part to disclose said identification code.

4. A method of manufacturing an optical information carrier, comprising the steps of:
providing a circular disk-shaped substrate member of a relatively rigid transparent material;
applying an information carrying layer to one surface of the substrate member, said layer providing on the side thereof facing the substrate member a reflective surface and a plurality of information or data carrying structures;
storing information in said structures, which is readable by an optical reading system of a computer device for inputting and storing utility information to said computer device, said information including in addition to said utility information control data required for the inputting and storing operation of the computer device, said control data being confined to a subset of said information and data carrying structures with a predetermined position in said layer, wherein the improvement comprises the additional steps of;
providing a security member carrying a unique secret identification code;
bonding said security member to a part of said information and data carrying layer containing a part of said subset by a bond causing modification of said reflective layer and/or the control data stored in said part of the subset to remove readability of said control data by detachment of the security member; and
structuring said control information to include information causing the computer device to invite a user to enter said identification code and to disrupt inputting of said useful information to the computer until entry of the security code has been completed.

5. A method as claimed in claim 4, wherein said structuring step comprises inclusion in said control data of a specified time delay after said invitation to the user for completion of entry of said identification code.

6. A method of using an optical information carrier of the kind comprising a circular disk-shaped substrate member of a relatively rigid transparent material and an information carrying layer applied to one surface of the substrate member and providing on the side thereof facing the substrate member a reflective surface and a plurality of information or data carrying structures, said information including control data for inputting and storing operations of a computer device, said control data being confined to a subset of said information or data carrying structures with a predetermined position in said layer, a detachable security member being bonded to a part of the information carrying layer including a part of said subset of the information or data carrying structures by a bond causing modification of the reflective surface and/or the control data stored in said part of the subset to remove readability of said control data by detachment of the security member, said security member carrying a unique secret identification code, which is made accessible to a user only by said detachment, said control data including information causing the computer device to invite a user to enter said identification code and to disrupt inputting of said utility information to the computer until entry of the security code has been completed, said method comprising the steps of:
entering the optical information carrier into an optical reading system of a computer device;
controlling the computer device by the control data contained in said subset of the information and data structures on the optical information carrier to request entry of said unique secret identification code;
removing the optical information carrier from said optical reading system;
detaching said security member from the optical information carrier;
accessing said unique identification code carried by the security member; and
entering said code into said computer device to enable said computer device for inputting and storing of said utility information.

7. A method as claimed in claim 6, wherein said controlling step comprises control of the computer device to request completion of said removing, detaching, accessing and entering steps within a specified time delay after said request and to disable operation of the computer device with respect to the information carrier after lapse of said time delay.
